(19) United States
(12) Patent Application Publication
(10) Pub. No.: US 2020/0246993 A1
(43) Pub. Date: Aug. 6, 2020

(54) DEVICE FOR AUTOMATICALLY CUTTING FROZEN FOOD PRODUCTS INTO PORTIONS OF AN EXACT WEIGHT

(71) Applicant: ASTECH FOOD MACHINERY, S.L., CORNELLA DEL TERRI (ES)

(72) Inventor: Ricard MASOLIVER FEIXAS, Cornella Del Terri (ES)

(73) Assignee: ASTECH FOOD MACHINERY, S.L., CORNELLA DEL TERRI (ES)

(21) Appl. No.: 16/651,038

(22) PCT Filed: Dec. 11, 2018
(86) PCT No.: PCT/ES2018/070796

§ 371 Date: Mar. 26, 2020

(30) Foreign Application Priority Data
Dec. 18, 2017 (ES) P201731417

(51) Int. Cl. B26D 5/00; B26D 7/02; B26D 7/06; B26D 7/30; A22C 17/00; A22C 25/18

(52) U.S. Cl. CPC B26D 5/005; B26D 5/007; B26D 7/02; B26D 2007/011; B26D 7/30; A22C 17/0006; A22C 25/18; B26D 7/0625

(57) ABSTRACT

A device for automatically cutting frozen food products into portions of an exact weight, including: an entry feeder that moves longitudinally a piece of a product to be cut; a detector that provides signals suitable for determining the total length and position of the end of the piece; a motorised movable head provided with claws for gripping and moving the piece of product in a longitudinal direction from the entry feeder to a cutting area; a scanner that determines the cross section of the piece of product during the movement thereof; a cutting area provided with a vertical band saw and a carriage that moves the piece to be cut, in a transverse and alternating manner; and a programmable automaton for programming the operation of the cutting device.

### OBJECT OF THE INVENTION

The object of the invention is a device for automatically cutting frozen food products, in particular products with an elongated or bar-shaped configuration, which has features aimed at performing the cutting of the product into portions of an exact weight.

### FIELD OF APPLICATION OF THE INVENTION

This invention is applicable to the sector dedicated to the manufacturing of cutting devices for frozen food products.

### STATE OF THE ART

Different cutting devices are currently known which have features suitable for cutting slices or portions of food products, the features of these devices being clearly different, depending on whether they are intended for cutting fresh or soft food products, or hard food products, for example, frozen and even bone-in products.

In the devices for cutting soft food products, it is common to use machines provided with a circular blade and with means for adjusting the gap between the blade and a front support and lateral movement surface of the piece of product to be cut, said gap determining the width of the slices or portions to be obtained.

Frozen food products have a much greater hardness, which is why the cutting thereof is usually carried out using a band saw, the operator being in charge of bringing the piece of product closer to the band and moving it laterally for the cutting thereof in portions.

This technique, in addition to being dangerous due to the risk of cutting the operator, has the drawback that the portions obtained will have a variable weight, depending in each case on the cross section of the piece in each of the cutting areas and the space between consecutive cuts.

As for frozen food marketing companies, there is an interest in the fact that the frozen product portions obtained have a predetermined exact weight, or with small variations, thus avoiding frozen product portions from being obtained with irregular, disproportionate weight and which are difficult to sell.

Therefore, the technical problem that arises is the development of a device capable of automatically cutting of frozen food products with an elongated or bar-shaped configuration, in portions of a predetermined exact weight, automatically calculated by the device based on the cross section of the piece to be cut and the progress to be made by the piece between consecutive cuts, taking into consideration that the frozen product, such as fish or meat, has an essentially constant density, which makes it possible to obtain pieces of an exact weight based on the volume thereof, the device performing an initial movement of the piece of frozen product in a longitudinal direction and subsequently, in a cutting area, a combination of alternating movements in transverse direction and a longitudinal movement of variable length depending on the cross section of the piece in the cutting area.

It should be noted, on the other hand, that the applicant is unaware of the existence of prior art that presents technical, structural and constitutive features similar to those presented by the title advocated herein, as claimed.

### DESCRIPTION OF THE INVENTION

The device for automatically cutting frozen food products of the invention is configured as an alternative novelty within the field of application thereof, since, according to its implementation, the aforementioned objectives are achieved, with the characterising details that distinguish it from what is already known, conveniently included in the claims of the invention.

According to the invention, this device for automatically cutting frozen food products into portions of exact weight comprises: an entry feeder that longitudinally moves a piece of a frozen food product to be cut towards a cutting area; a detector arranged in a product passage area and that provides signals suitable for determining the total length of the product piece and the position of the end of the piece; a motorised movable head provided with claws for gripping and moving the piece of product in a longitudinal direction from the entry feeder towards a cutting area; a scanner that determines the cross section of the piece of product during the movement thereof towards the cutting area; a cutting area provided with a vertical band saw arranged in a fixed position, and a carriage for transverse and alternating movement of a piece of product in a cutting direction and in a direction of return to the initial position; and, a programmable automaton for programming and selecting the operating parameters of the cutting device.

The carriage for transverse movement is motorised and movably mounted on transverse guides.

Based on the information received from the detector and the volume scanner, the automaton controls the alternating movements of the carriage for transverse movement and the longitudinal advance movements of the movable head, adjusting them such that the band saw performs the cutting of the product in consecutive portions of an exact weight.

In this way, portions of frozen product are obtained with a predetermined exact weight and with a greater or lesser length, depending on whether they have a smaller or larger cross section.

The features of the invention shall be more readily understandable in light of the exemplary embodiment shown in the attached figures described below.

### DESCRIPTION OF THE FIGURES

As a complement to the description provided herein, and for the purpose of helping to make the features of the invention more readily understandable, the present specification is accompanied by a set of drawings which, by way of illustration and not limitation, represent the following:

FIG. 1 shows a schematic perspective view of an exemplary embodiment of the cutting device according to the invention.

FIG. 2 shows a schematic elevation view of the cutting device of the previous figure.

FIGS. 3 to 11 show respective explanatory details of the operation of the device from the entrance of the piece of frozen product to the cutting thereof into portions.

### PREFERRED EMBODIMENT OF THE INVENTION

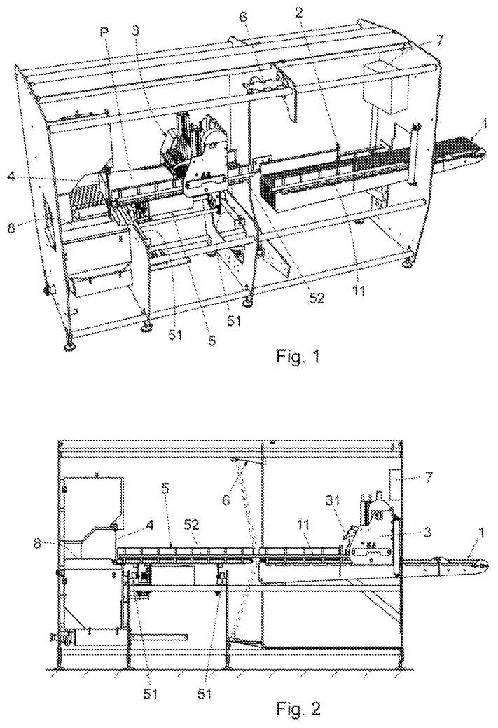

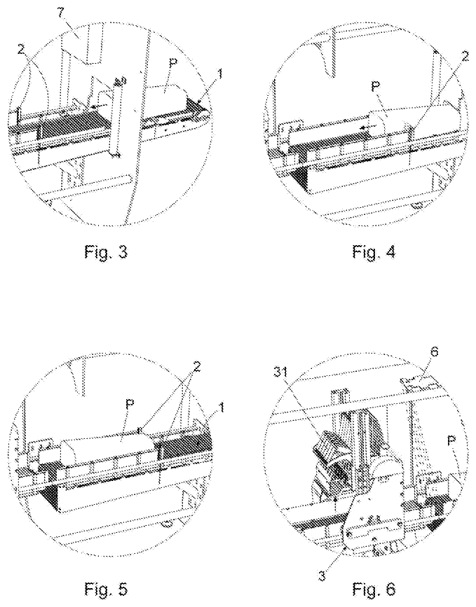

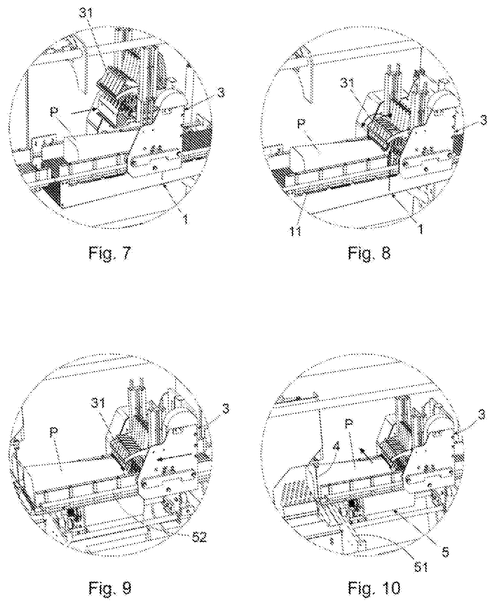

As seen in FIGS. 1 and 2, this device for automatically cutting frozen food products into portions of exact weight comprises an entry feeder (1) for longitudinally moving a piece (P) of a food product to be cut towards a cutting area and a detector (2) arranged in a product passage area, as shown in FIGS. 3 to 5, and which provides signals suitable for determining the total length of the piece (P) of product and the position of the end of the piece.

The movable head (3) has a configuration suitable for the passage of the piece (P) of product below the same and it is provided with rotating claws (31) for gripping and moving the piece (P) of product in a longitudinal direction from the entry feeder (1) to a cutting area provided with a vertical band saw (4), arranged in a fixed position for cutting the piece of product, and with a carriage (5) for transverse and alternating movement, motorised and mounted on transverse guides (51); said carriage (5) being in charge of moving transversely the piece of product in a cutting direction and in a direction of return to the initial position.

Arranged between the entry feeder (1) and the carriage (5) for transverse movement is a scanner (6) that determines the cross section of the piece (P) of product along the same, during the movement of the piece of product towards the cutting area.

The cutting device further comprises a programmable automaton (7) for programming its operation thereof and which, depending on the information received from the detector (2) and the volume scanner (5), controls the alternating movements of the carriage (5) for transverse movement and the longitudinal advance movements of the movable head (3) for cutting the product (P) in consecutive portions of an exact weight.

With the elements indicated, the operation of the cutting device is as follows:

As shown in FIGS. 3 to 5, the work cycle begins with the user loading the piece (P) of product in the entry feeder (1), which moves it longitudinally. The detector (2) detects the start of the product that continues to advance until it moves beyond the detector (2), causing the feeder (1) to stop. The information provided by said detector (2) makes it possible to know the total length of the product and the position of the end of the product.

As shown in FIG. 6, the claws (31) of the movable head (3) open vertically to enable the passage of the product under the head that moves on longitudinal guides (52) of the carriage (5) for transverse movement and on longitudinal guides (11) of the feeder until it is positioned behind the piece of product, to perform the grip thereof with the claws (31) at the rear end thereof, as shown in FIG. 8.

As shown in FIG. 9, the movable head (3) moves longitudinally towards the cutting area, positioning the piece (P) of product on the carriage (5) for transverse movement.

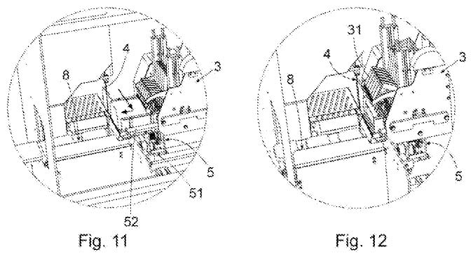

In FIG. 10, the carriage (5) has moved along the guides (51) in the transverse direction and direction opposite to cutting, to prepare for the cut, and the movable head (3) has moved the piece (P) in longitudinal direction in a measure predetermined by the automaton and corresponding to the width of the portion of the product, of exact weight, to be obtained.

As the carriage (5) moves transversely in the cutting direction, the band saw (4) causes the cutting of a portion of the product, which falls on an extraction belt 8, as shown in FIG. 11.

By orderly repeating the transverse movement of the carriage (5) in the direction opposite to that of cutting, the advance of the head (3) and the transverse movement of the carriage (5) in the cutting direction, the band saw (4) performs the cutting of the piece (P) in consecutive portions of exact weight, until the claws (31) of the movable head (3) are positioned in front of the product extraction belt (8) and open, expelling the last portion of product, as shown in FIG. 12.

Having sufficiently described the nature of the invention, in addition to a preferred exemplary embodiment, it is hereby stated for the relevant purposes that the materials, shape, size and layout of the described elements may be modified, provided that it does not imply altering the essential features of the invention claimed below.

1-2. (canceled)

3. A device for automatically cutting frozen food products into portions of an exact weight comprising:
an entry feeder that longitudinally moves a piece of a food product to be cut towards a cutting area;
a detector arranged in a product passage area that provides signals suitable for determining the total length of the piece of product and the position of the end of the piece;
a motorised movable head with a configuration suitable for the passage of the piece of product below it and provided with claws for gripping and moving the piece of product in a longitudinal direction from the entry feeder to a cutting area;
a scanner that determines the cross section of the piece of product along the same, during the movement thereof towards the cutting area;
a cutting area provided with a vertical band saw arranged in a fixed position and a carriage for transverse alternating movement of the piece of product in a cutting direction and in a direction of return to the initial position; said carriage being motorised and movably mounted on transverse guides;
a programmable automaton for programming the operation of the cutting device and which, depending on the information received from the detector and the volume scanner, controls the alternating movements of the carriage of transverse movement and the longitudinal advance movements of the movable head for cutting the product in consecutive portions of an exact weight; and
respective sections of guides in the entry feeder and in the carriage for transverse movement for the movement of the movable head in longitudinal direction.

4. The cutting device, according to claim 3, wherein the cutting area comprises, after the band saw, a belt for extracting the cut product.
